(19) United States
(12) Patent Application Publication
(10) Pub. No.: US 2022/0383876 A1
(43) Pub. Date: Dec. 1, 2022

(54) METHOD OF CONVERTING SPEECH, ELECTRONIC DEVICE, AND READABLE STORAGE MEDIUM

(71) Applicant: Beijing Baidu Netcom Science Technology Co., Ltd., Beijing (CN)

(72) Inventors: Yixiang CHEN, Beijing (CN); Junchao WANG, Beijing (CN); Yongguo KANG, Beijing (CN)

(21) Appl. No.: 17/818,609

(22) Filed: Aug. 9, 2022

(30) Foreign Application Priority Data
Aug. 9, 2021 (CN) 202110909497.9

(51) Int. Cl. G10L 15/26; G10L 15/16; G10L 15/02

(52) U.S. Cl. CPC G10L 15/26; G10L 15/16; G10L 15/02

(57) ABSTRACT

A method of converting a speech, an electronic device, and a readable storage medium are provided, which relate to a field of artificial intelligence technology such as speech and deep learning, in particular to speech converting technology. The method of converting a speech includes: acquiring a first speech of a target speaker; acquiring a speech of an original speaker; extracting a first feature parameter of the first speech of the target speaker; extracting a second feature parameter of the speech of the original speaker; processing the first feature parameter and the second feature parameter to obtain a Mel spectrum information; and converting the Mel spectrum information to output a second speech of the target speaker having a tone identical to a tone of the first speech of the target speaker and a content identical to a content of the speech of the original speaker.

### CROSS-REFERENCE TO RELATED APPLICATIONS

This application is claims priority to Chinese Application No. 202110909497.9 filed on Aug. 9, 2021, which is incorporated herein by reference in its entirety.

### TECHNICAL FIELD

The present disclosure relates to a field of artificial intelligence technology such as speech and deep learning, in particular to speech converting technology.

### BACKGROUND

Speech conversion refers to changing a speech personality feature of an original speaker to a speech personality feature of a target speaker on the premise of retaining original semantic information, so that a speech of a person sounds like a speech of another person after the converting. Research for speech converting has very important application value and theoretical value. Since it is impossible for any acoustic feature parameter to represent all the personality information of a person, generally speech personality feature parameter that is most representative for different people is chosen for speech conversion.

### SUMMARY

According to an aspect of the present disclosure, there is provided a method of converting a speech, including:
acquiring a first speech of a target speaker;
acquiring a speech of an original speaker;
extracting a first feature parameter of the first speech of the target speaker;
extracting a second feature parameter of the speech of the original speaker;
processing the first feature parameter and the second feature parameter to obtain a Mel spectrum information; and
converting the Mel spectrum information to output a second speech of the target speaker having a tone identical to a tone of the first speech of the target speaker and a content identical to a content of the speech of the original speaker.

According to another aspect of the present disclosure, there is provided an electronic device, including:
at least one processor; and
a memory communicatively connected to the at least one processor, wherein the memory stores instructions executable by the at least one processor, and the instructions, when executed by the at least one processor, cause the at least one processor to implement the method of the present disclosure.

According to a fourth aspect of the present disclosure, there is provided non-transitory computer-readable storage medium having computer instructions stored thereon, wherein the computer instructions are configured to cause a computer to implement the method of the present disclosure.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 shows a schematic diagram of a method of converting a speech according to embodiments of the present disclosure.

FIG. 2 shows a schematic diagram of extracting a first feature parameter of the first speech of the target speaker according to embodiments of the present disclosure.

FIG. 3 shows a schematic diagram of extracting a second feature parameter of the speech of the original speaker according to embodiments of the present disclosure.

FIG. 4 shows a schematic diagram of processing the text-like feature to obtain the first fundamental frequency and the first fundamental frequency representation according to embodiments of the present disclosure.

FIG. 5 shows a schematic diagram of a system of converting a speech according to embodiments of the present disclosure.

FIG. 6 shows a schematic diagram of a first extracting module according to embodiments of the present disclosure.

FIG. 7 shows a schematic diagram of a second extracting module according to embodiments of the present disclosure.

FIG. 8 shows a schematic diagram of a processing module according to embodiments of the present disclosure.

FIG. 9 shows a block diagram of an electronic device used to implement a system of converting a speech according to the embodiments of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

A speech conversion system refers to a system that converts a speech of a source speaker into a speech having a tone identical to a tone a target speaker. The speech conversion system is like a voice changer. As compared to the voice changer which is primitive, the speech conversion system may provide a speech which is more authentic and pleasant to hear and has a tone being closer to the tone of the target speaker. Besides, the speech conversion system may further fully retain the text and emotional information, so as to achieve a replaceability of the target speaker to a great extent.

According to embodiments of the present disclosure, a method and a system of convening a speech, an electronic device, and a readable storage medium are provided, which are applicable to improve an effect of speech conversion and retain a tone of an original speech.

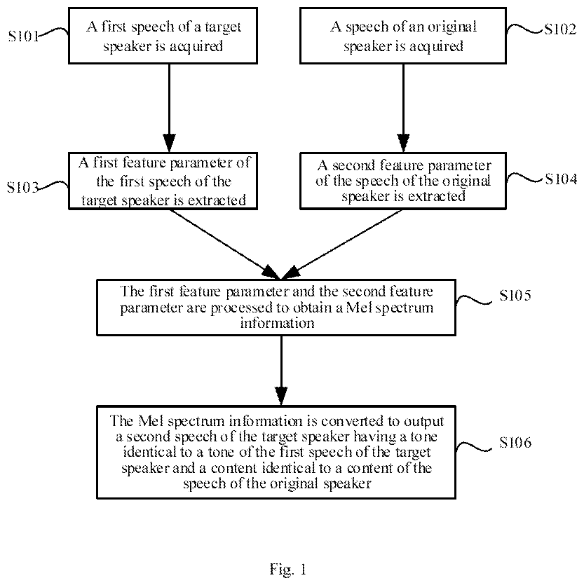

As shown in FIG. 1, a method of converting a speech is provided according to embodiments of the present disclosure. The method includes following operations.

In operation S101, a first speech of a target speaker is acquired. The target speaker refers to a target object for speech conversion. In this operation, it is also possible to acquire text information and then convert the text information into the first speech of the target speaker. A specific target speaker is specified. Thus, generalization is not considered in the entire calculation method, so that a compressible space for the calculation is increased, and a cost of the calculation is reduced.

In operation S102, a speech of an original speaker is acquired. The speech of the original speaker is a speech of an object to be converted. In this operation, it is also possible to acquire text information and then convert the text information into the speech of the original speaker.

In operation S103, a first feature parameter of the first speech of the target speaker is extracted. A feature parameter of human speech information contains various features, and each feature plays a respective role in speech expression. Acoustic parameters that characterize tone features substantially include voiceprint feature, formant bandwidth, Mel cepstrum coefficient, formant position, speech energy, and pitch period, etc. A reciprocal of the pitch period is the fundamental frequency. The extracted parameter of the first speech of the target speaker may include any one or more of the above parameters.

In operation S104, a second feature parameter of the speech of the original speaker is extracted. Like the first feature parameter as described above, the second feature parameter also substantially includes various parameters as described above. In addition, the extracted parameter of the information contained in the speech of the original speaker further includes text codes, a first fundamental frequency, and a first fundamental frequency representation.

In operation S105, the first feature parameter and the second feature parameter are processed to obtain a Mel spectrum information.

In operation S106, the Mel spectrum information is converted to output a second speech of the target speaker having a tone identical to a tone of the first speech of the target speaker and a content identical to a content of the speech of the original speaker. Converting the speech of the original speaker to the speech of the target speaker may be applied to many fields, such as fields of speech synthesis, multimedia, medicine, speech translation and so on.

Both the acquired first speech of the target speaker and the acquired speech of the original speaker are audio information. It is more direct to directly use the audio information for speech conversion, which also makes the converted speech clearer. Moreover, the audio information contains phonemes such as speech content, emotion, tone and the like of the speaker.

The first feature parameter includes a voiceprint feature with a time dimension information.

With the method and system of converting a speech according to embodiments of the present disclosure, tone characteristics such as speech emotion and accent may be retained, such that the tone is closer to the tone of the target speaker. With the method and system of converting a speech according to embodiments of the present disclosure, the computation cost may be reduced.

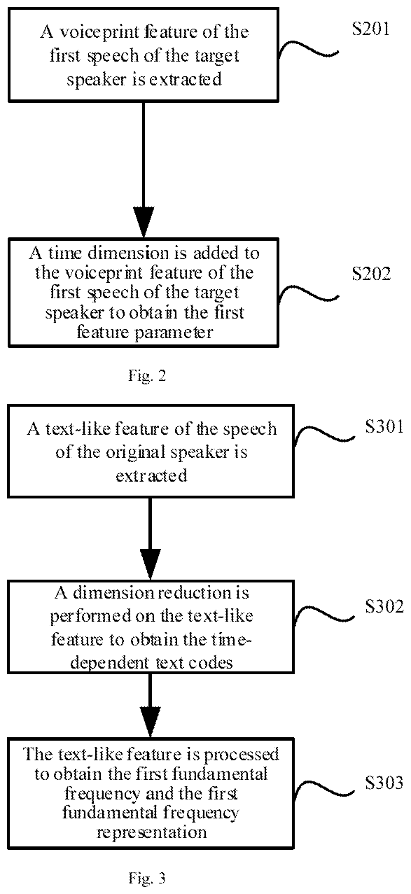

As shown in FIG. 2, extracting the first feature parameter of the first speech of the target speaker includes following operations.

In operation S201, a voiceprint feature of the first speech of the target speaker is extracted. Similar to human fingerprint, the voiceprint feature is a unique and definite feature of a speaker, and one speaker has only one voiceprint feature.

In operation S202, a time dimension is added to the voiceprint feature of the first speech of the target speaker to obtain the first feature parameter. As illustrated above, it is confirmed that the voiceprint feature is a parameter irrelevant to time. Here, associating the voiceprint feature to time is to facilitate processing the first feature parameter together with the second feature parameter in following operations. Not only a convolution layer, but also a long short-term memory network is used for voiceprint feature processing.

The second feature parameter includes time-dependent text codes, a first fundamental frequency, and a first fundamental frequency representation. The time-dependent “text codes” is emphasized here because the speech is continuous and time-dependent finally in the speech conversion, that is, phrases in a sentence are ordered in time. In addition, if a sentence or a paragraph is divided by words instead of being divided by time, individual words may be combined and transformed into the speech of the target speaker. In this way, a sentence or a paragraph may lack of the speech emotion, accent, and tone information of the original speaker, and thus is very stiff. If the sentence or the paragraph is divided based on time, then a sentence or a paragraph having speech account and tone information may be combined and transformed into the speech of the target speaker. Apparently, the time-dependent text codes are more conducive to the speech effect after speech conversion.

As shown in FIG. 3, extracting the second feature parameter of the speech of the original speaker includes following operations.

In operation S301, a text-like feature of the speech of the original speaker is extracted. The text-like feature is a time-dependent text feature. For example, a sentence spoken by the original speaker is extracted, so that the text-like feature includes both semantic and time information. In other words, each word in a sentence appears in a time order, or each phrase in a paragraph appears in a time order.

In operation S302, a dimension reduction is performed on the text-like feature to obtain the time-dependent text codes. The text-like feature and the time-dependent text codes are vectors obtained for each frame of speech. The dimension reduction is performed on the text-like feature to reduce an amount of computation. Here, only the convolution layer is used for the dimension reduction.

In operation S303, the text-like feature is processed to obtain the first fundamental frequency and the first fundamental frequency representation. The text-like feature is time-dependent, so the processed first fundamental frequency and the processed first fundamental frequency representation are also time-dependent. That is, the first fundamental frequency and the first fundamental frequency representation also correspond to each frame of speech.

As shown in FIG. 4, processing the text-like feature to obtain the first fundamental frequency and the first fundamental frequency representation includes following operations.

In operation S401, a neural network is trained by using the speech of the original speaker and the text-like feature, so as to acquire a mapping model for mapping the text-like feature to a fundamental frequency.

In the process of training the neural network, a fundamental frequency in the speech of the original speaker is extracted, and a text-like feature corresponding to the fundamental frequency in the speech of the original speaker is extracted. In this way, the mapping model for mapping the text-like feature to the fundamental frequency may be obtained. In the training process, the fundamental frequency in the speech of the original speaker may be used for training adjustment. Two loss functions may be used in the training process, one loss function is a loss function for the fundamental frequency, and the other loss function is a self-refactoring loss function for the speech of the original speaker.

In operation S402, the text-like feature is processed by using the mapping model for mapping the text-like feature to the fundamental frequency, so as to obtain the first fundamental frequency and the first fundamental frequency representation. In a stage of practical application, the mapping model obtained in the training stage for mapping the text-like feature to the fundamental frequency is used to predict the first fundamental frequency based on the text-like information. Moreover, a hidden layer of an output of the mapping model outputs the first fundamental frequency representation. In addition, a long short-term memory network is added to the mapping model for mapping the text-like feature to fundamental frequency. The reason for adding the long short-term memory network is that the fundamental frequency is not only time-dependent, but also context-dependent. Therefore, the long short-term memory network is used to add time information to the mapping model for mapping the text-like feature to the fundamental frequency. Similarly, in this operation, the process is performed based on the fundamental frequency of a sentence or a paragraph, rather than the fundamental frequency of a word. That is, the subsequent speech conversion is performed according to the time-dependent and context-dependent fundamental frequency. An advantage of this is that the speech emotion, accent and other tone elements of the original speaker are retained after the conversion.

Training the neural network includes training based on the convolution layer and the long short-term memory network. The convolution layer is mainly used for dimension reduction, and the long short-term memory network is mainly used to add time information to the mapping model for mapping the text-like feature to the fundamental frequency.

So far, the time-dependent voiceprint feature is obtained by processing the voiceprint feature, and the text codes are obtained by performing the dimension reduction on the text-like feature by the convolution layer. The text codes are time-dependent, and the first fundamental frequency is also time-dependent. The first fundamental frequency is time-dependent, that is, each frame has one fundamental frequency. The text-like feature is also time-dependent, that is, each frame has one text-like feature. However, the fundamental frequency is a number, while the text-like feature is a vector. Therefore, the text-like feature is mapped to a fundamental frequency. That is, on the one hand, the dimension reduction is performed on the text-like feature to obtain the text codes, and on the other hand, a mapping from the text-like feature to a frequency domain is established. Here, the convolution layer is used for dimension reduction. Besides, the convolution layer is further used to transform data space to map the text-like feature to the fundamental frequency.

Processing the first feature parameter and the second feature parameter to obtain the Mel spectrum information includes: performing an integration encoding on the first feature parameter and the second feature parameter to obtain an encoded feature of each frame of speech; and inputting the encoded feature of each frame to a decoder to obtain the Mel spectrum information.

The first feature parameter here refers to time-dependent voiceprint feature codes, and the second feature parameter here refers to the time-dependent text codes and the first fundamental frequency. The time-dependent text codes is integrated with the first fundamental frequency by being directly spliced together with the first fundamental frequency. The voiceprint feature codes are added to the text codes by calculating a weight matrix and an offset vector, that is, transforming the voiceprint feature codes into a fully connected layer network, and then calculating the fully connected layer network with the text codes. In this manner, the voiceprint feature information is added to the text codes.

Then, the obtained Mel spectrum information is input into a vocoder, and the vocoder converts the Mel spectrum information into a speech audio. The speech audio is a speech that retains the tone of the target speaker and has a content being the content of the speech of the original speaker. The purpose of converting a speech is achieved. The vocoder may be implemented in any suitable manner, which will not be repeated here.

According to the embodiments of the present disclosure, extracting and processing of the fundamental frequency of the speech of the original speaker is introduced on the basis of speech conversion technology, so that characteristics such as emotion and accent of the speech may be retained according to the method and system of converting a speech. With the above method and system, a computing cost and a requirement for hardware in the speech conversion are reduced.

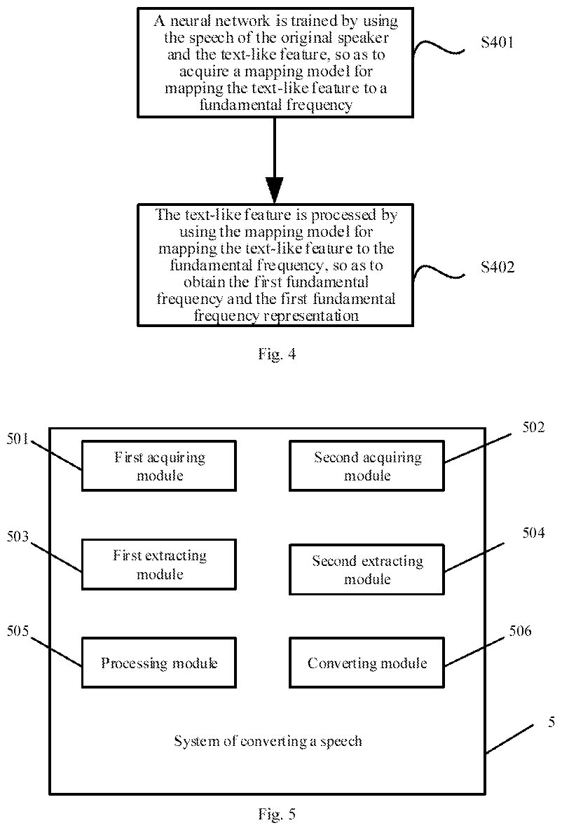

As shown in FIG. 5, according to embodiments of the present disclosure, a system of converting a speech is further provided. The system includes a first acquiring module 501, a second acquiring module 502, a first extracting module 503, a second extracting module 504, a processing module 505, and a converting module 506.

The first acquiring module 501 is used to acquire a first speech of a target speaker.

The second acquiring module 502 is used to acquire a speech of an original speaker.

The first extracting module 503 is used to extract a first feature parameter of the first speech of the target speaker.

The second extracting module 504 is used to extract a second feature parameter of the speech of the original speaker.

The processing module 505 is used to process the first feature parameter and the second feature parameter to obtain a Mel spectrum information; and

The converting module 506 is used to convert the Mel spectrum information to output a second speech of the target speaker having a tone identical to a tone of the first speech of the target speaker and a content identical to a content of the speech of the original speaker.

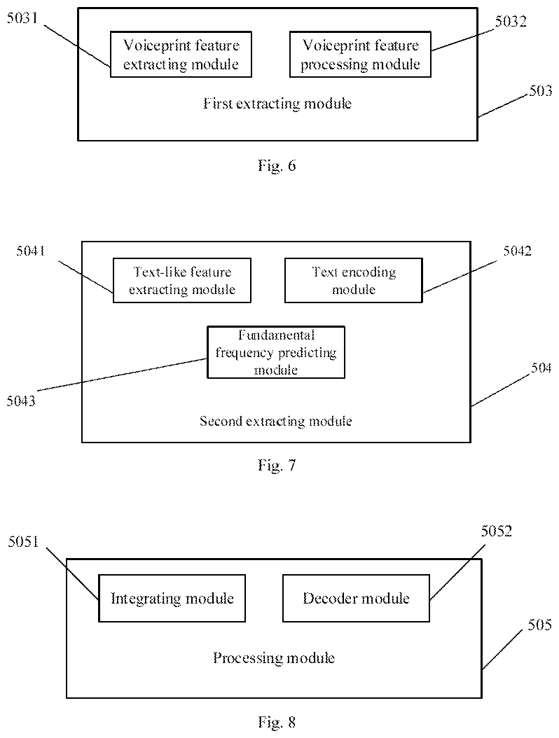

As shown in FIG. 6, the first extracting module 503 includes a voiceprint feature extracting module 5031 and a voiceprint feature processing module 5032.

The voiceprint feature extracting module 5031 is used to extract a voiceprint feature of the first speech of the target speaker.

The voiceprint feature processing module 5032 is used to add a time dimension to the voiceprint feature of the first speech of the target speaker to obtain the first feature parameter.

As shown in FIG. 7, the second extracting module 504 includes: a text-like feature extracting module 5041, a text encoding module 5042, and a fundamental frequency predicting module 5043.

The text-like feature extracting module 5041 is used to extract a text-like feature of the speech of the original speaker.

The text encoding module 5042 is used to perform a dimension reduction on the text-like feature to obtain the time-dependent text codes.

The fundamental frequency predicting module 5043 is used to process the text-like feature to obtain the first fundamental frequency and the first fundamental frequency representation. An input of the fundamental frequency predicting module 5043 is the text-like feature, and an output of the fundamental frequency predicting module 5043 is a fundamental frequency and a hidden layer feature in the fundamental frequency predicting module. The fundamental frequency predicting module aims to predict the fundamental frequency based on the text-like feature. In a training stage, a true fundamental frequency is used as a target to calculate a loss function. In an application stage, the fundamental frequency is predicted based on the text-like feature. The fundamental frequency predicting module 5043 is a neural network in nature.

As shown in FIG. 8, the processing module 505 includes an integrating module 5051 and a decoder module 5052.

The integrating module 5051 is used to perform an integration encoding on the first feature parameter and the second feature parameter to obtain an encoded feature of each frame of speech.

The decoder module 5052 is used to input the encoded feature of each frame to a decoder to obtain the Mel spectrum information.

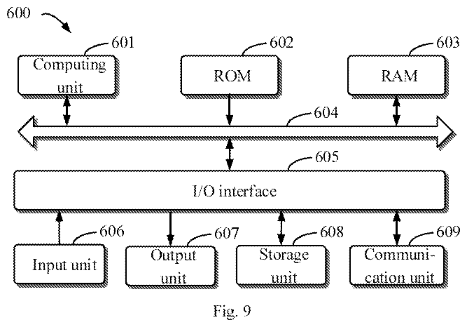

As shown in FIG. 9, according to embodiments of the present disclosure, an electronic device is provided including:
at least one processor; and
a memory communicatively connected to the at least one processor, wherein the memory stores instructions executable by the at least one processor, and the instructions, when executed by the at least one processor, cause the at least one processor to implement the method according to embodiments of the present disclosure.

According to embodiments of the present disclosure, there is provided a non-transitory computer-readable storage medium having computer instructions stored thereon, wherein the computer instructions are used to cause a computer to implement the method according to embodiments of the present disclosure.

According to embodiments of the present disclosure, there is provide a computer program product containing a computer program, wherein the computer program, when executed by a processor, causes the processor to implement the method according to embodiments of the present disclosure.

Collecting, storing, using, processing, transmitting, providing, and disclosing etc, of the personal information of the user involved in the present disclosure all comply with the relevant laws and regulations, are protected by essential security measures, and do not violate the public order and morals. According to the present disclosure, personal information of the user is acquired or collected after such acquirement or collection is authorized or permitted by the user.

According to the embodiments of the present disclosure, an electronic device, a readable storage medium, and a computer program product are further provided.

FIG. 9 shows a schematic block diagram of an exemplary electronic device 600 for implementing the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and ae not intended to limit the implementation of the present disclosure described and/or required herein.

As shown in FIG. 9, the device 600 may include a computing unit 601, which may perform various appropriate actions and processing based on a computer program stored in a read-only memory (ROM) 602 or a computer program loaded from a storage unit 608 into a random access memory (RAM) 603. Various programs and data required for the operation of the device 600 may be stored in the RAM 603. The computing unit 601, the ROM 602 and the RAM 603 are connected to each other through a bus 604. An input/output (I/O) interface 605 is further connected to the bus 604.

Various components in the electronic device 600, including an input unit 606 such as a keyboard, a mouse, etc., an output unit 607 such as various types of displays, speakers, etc., a storage unit 608 such as a magnetic disk, an optical disk, etc., and a communication unit 609 such as a network card, a modem, a wireless communication transceiver, etc., are connected to the I/O interface 605. The communication unit 609 allows the device 600 to exchange information data with other devices through a computer network such as the Internet and/or various telecommunication networks.

The computing unit 601 may be various general-purpose and/or special-purpose processing components with processing and computing capabilities. Some examples of the computing unit 601 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 601 may perform the method and processing described above, such as the method of converting a speech. For example, in some embodiments, the method of converting a speech may be implemented as a computer software program that is tangibly contained on a machine-readable medium, such as the storage unit 608. In some embodiments, part or all of a computer program may be loaded and/or installed on the electronic device 600 via the ROM 602 and/or the communication unit 609. When the computer program is loaded into the RAM 603 and executed by the computing unit 601, one or more steps of the method of converting a speech described above may be performed. Alternatively, in other embodiments, the computing unit 601 may be used to perform the method of converting a speech in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (fir example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server (also known as a cloud computing server or a cloud host), which is a host product in a cloud computing service system to solve a problem of defects of difficult management and weak business expansion exist in traditional physical hosts and VPS (Virtual Private Server) services. The server may also be a server of a distributed system, or a server combined with a blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

### DESCRIPTION OF REFERENCE SIGNS

5 System of converting a speech
501 First acquiring module
502 Second acquiring module
503 First extracting module
504 Second extracting module
5031 Voiceprint feature extracting module
5032 Voiceprint feature processing module
5041 Text-like feature extracting module
5042 Text encoding module
5043 Fundamental frequency predicting module
505 Processing module
506 Converting module
5051 Integrating module
5052 Decoder module
600 Electronic device
601 Computing unit
602 Read only memory
603 Random access memory
604 Bus
605 I/O interface
606 Input unit
607 Output unit
608 Storage unit
609 Communication unit

### Explanation of Terms

Fundamental frequency: Fundamental frequency is a sine wave having the lowest frequency in a sound. The fundamental frequency may represent a pitch of the sound. The fundamental frequency is the pitch of the sound in singing.

Voiceprint feature: Voiceprint feature is a feature vector that stores a tone of a speaker. Ideally, each speaker has a unique and definite voiceprint feature vector, which may completely represent the speaker, like the fingerprint does.

Mel spectrum: The unit of frequency is Hertz, and a range of frequency that human ear may hear is 20-20000 Hertz. However the sensitivity of human ears to frequencies in Hertz unit is not linear. Human ears are sensitive to low frequencies in Hertz and insensitive to high frequencies in Hertz. Perception of human ears to frequencies becomes linear if the frequencies in Hertz are converted to Mel frequencies.

Long short-term memory (LSTM) network: LSTM network is a Time Recurrent Neural Network.

Vocoder: Vocoder is used to synthesize Mel spectrum information into speech waveform signals.

What is claimed is:

1. A method of converting a speech, comprising:
acquiring a first speech of a target speaker;
acquiring a speech of an original speaker;
extracting a first feature parameter of the first speech of the target speaker;
extracting a second feature parameter of the speech of the original speaker;
processing the first feature parameter and the second feature parameter to obtain a Mel spectrum information; and
converting the Mel spectrum information to output a second speech of the target speaker having a tone identical to a tone of the first speech of the target speaker and a content identical to a content of the speech of the original speaker.

2. The method according to claim 1, wherein both the acquired first speech of the target speaker and the acquired speech of the original speaker are audio information.

3. The method according to claim 1, wherein the first feature parameter comprises a voiceprint feature with a time dimension information.

4. The method according to claim 3, wherein the extracting a first feature parameter of the first speech of the target speaker comprises:
extracting a voiceprint feature of the first speech of the target speaker; and
adding a time dimension to the voiceprint feature of the first speech of the target speaker to obtain the first feature parameter.

5. The method according to claim 1, wherein the second feature parameter comprises time-dependent text codes, a first fundamental frequency, and a first fundamental frequency representation.

6. The method according to claim 5, wherein the extracting a second feature parameter of the speech of the original speaker comprises:
extracting a text-like feature of the speech of the original speaker;
performing a dimension reduction on the text-like feature to obtain the time-dependent text codes; and
processing the text-like feature to obtain the first fundamental frequency and the first fundamental frequency representation.

7. The method according to claim 6, wherein the processing the text-like feature to obtain the first fundamental frequency and the first fundamental frequency representation comprises:
training a neural network by using the speech of the original speaker and the text-like feature, so as to acquire a mapping model for mapping the text-like feature to a fundamental frequency; and
processing the text-like feature by using the mapping model for mapping the text-like feature to the fundamental frequency, so as to obtain the first fundamental frequency and the first fundamental frequency representation.

8. The method according to claim 7, wherein the training a neural network comprises: training based on a convolution layer and a long short-term memory network.

9. The method according to claim 1, wherein the processing the first feature parameter and the second feature parameter to obtain a Mel spectrum information comprises:
performing an integration encoding on the first feature parameter and the second feature parameter to obtain an encoded feature of each frame of speech; and
inputting the encoded feature of each frame to a decoder to obtain the Mel spectrum information.

10. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 1.

11. The electronic device according to claim 10, wherein both the acquired first speech of the target speaker and the acquired speech of the original speaker are audio information.

12. The electronic device according to claim 10, wherein the first feature parameter comprises a voiceprint feature with a time dimension information.

13. The electronic device according to claim 12, wherein the at least one processor is further configured to:
extract a voiceprint feature of the first speech of the target speaker; and
add a time dimension to the voiceprint feature of the first speech of the target speaker to obtain the first feature parameter.

14. The electronic device according to claim 10, wherein the second feature parameter comprises time-dependent text codes, a first fundamental frequency, and a first fundamental frequency representation.

15. The electronic device according to claim 14, wherein the at least one processor is further configured to:
extract a text-like feature of the speech of the original speaker;
perform a dimension reduction on the text-like feature to obtain the time-dependent text codes; and
process the text-like feature to obtain the first fundamental frequency and the first fundamental frequency representation.

16. The electronic device according to claim 15, wherein the at least one processor is further configured to:
train a neural network by using the speech of the original speaker and the text-like feature, so as to acquire a mapping model for mapping the text-like feature to a fundamental frequency; and
process the text-like feature by using the mapping model for mapping the text-like feature to the fundamental frequency, so as to obtain the first fundamental frequency and the first fundamental frequency representation.

17. The electronic device according to claim 16, wherein the at least one processor is further configured to: train based on a convolution layer and a long short-term memory network.

18. The electronic device according to claim 10, wherein the at least one processor is further configured to:
perform an integration encoding on the first feature parameter and the second feature parameter to obtain an encoded feature of each frame of speech; and
input the encoded feature of each frame to a decoder to obtain the Mel spectrum information.

19. A non-transitory computer-readable storage medium having computer instructions stored thereon, wherein the computer instructions are configured to cause a computer to implement the method of claim 1.

20. The medium according to claim 19, wherein both the acquired first speech of the target speaker and the acquired speech of the original speaker are audio information.
